(19) United States
(12) Patent Application Publication
(10) Pub. No.: US 2019/0253090 A1
(43) Pub. Date: Aug. 15, 2019

(54) STOCHASTIC INTERFERENCE CANCELLATION

(71) Applicant: BLACK LATTICE TECHNOLOGIES, INC., Salt Lake City, UT (US)

(72) Inventors: JONATHAN C. HEDSTROM, Salt Lake City, UT (US); CHUNG HIM YUEN, Salt Lake City, UT (US); AHMAD REZAZADEHREYHANI, San Jose, CA (US); Kohl Riekhof, Cottonwood Heights, UT (US); BEHROUZ FARHANG, Salt Lake City, UT (US)

(73) Assignee: BLACK LATTICE TECHNOLOGIES, INC., Salt Lake City, UT (US)

(21) Appl. No.: 16/276,566

(22) Filed: Feb. 14, 2019

Related U.S. Application Data
(60) Provisional application No. 62/630,460, filed on Feb. 14, 2018.

(51) Int. Cl. H04B 1/10; H04B 7/0413; H04L 1/00

(52) U.S. Cl. CPC H04B 1/1081; H04L 1/0051; H04L 1/0048; H04B 7/0413

(57) ABSTRACT

Apparatuses, systems, and methods are disclosed for stochastic interference cancellation. A digital signal processor decodes a set of transmitted signals based on a set of received signals. A projection module updates a subset of a set of estimated signals based on error information and on a corresponding subset of mapping information. Error information is based on the received signals and the set of estimated signals. Mapping information indicates how the received signals are affected by the transmitted signals. A stochastic update module adjusts the set of estimated signals based on generated noise. An interference cancellation module updates the error information based on the adjusted estimated signals.

### CROSS-REFERENCES TO RELATED APPLICATIONS

This application claims the benefit of U.S. Provisional Patent Application No. 62/630,460 entitled “DEVICES, SYSTEMS, AND RELATED METHODS FOR STOCHASTIC INTERFERENCE CANCELLATION” and filed on Feb. 14, 2018 for Jonathan C. Hedstrom et al., which is incorporated herein by reference.

### STATEMENT REGARDING FEDERALLY SPONSORED RESEARCH OR DEVELOPMENT

This invention was made with government support under Grant No. 1632569 awarded by the National Science Foundation. The government has certain rights in the invention.

### FIELD

This invention relates to signal processing and more particularly relates to interference cancellation.

### BACKGROUND

In a multiple-input multiple-output (MIMO) system, a transmitter may use multiple transmit antennas to send multiple signals in parallel, and a receiver may use multiple receive antennas to receive multiple signals. Use of a MIMO system rather than a single-input single-output (SISO) system with one transmit antenna and one receive antenna may avoid or mitigate congestion in wireless networks, increase network capacity, or the like. However multiple signals sent in parallel may mix or interfere with each other. For example, a single receive antenna may not receive a signal from a single transmit antenna, but a mix of signals from multiple transmit antennas. Another receive antenna may receive a different mix of signals from the transmit antennas. Additionally, a signal from a transmit antenna may be delayed or attenuated differently, or may include different amounts of noise, when received at different receive antennas.

Multiple signals may also collide, mix, or interfere in other contexts. Inter-symbol interference (ISI), inter-carrier interference (ICI), inter-stream MIMO interference, cross-talk, multi-user interference, or other types of interference may occur in wireless and wired communications, image processing systems, video processing systems, and fiber optic communications, and the like. A variety of techniques exist for mitigating or compensating for interference to recover, unmix or estimate the originally transmitted signals. For example, a stronger component of a received signal may be decoded and subtracted from the received signal before decoding a weaker component of the received signal. However, the difficulty of estimating or unmixing the originally transmitted signals increases for multiple low-power (compared to noise) or similar-power signals. Additionally, attempts to cancel interference may introduce or propagate errors, or may amplify noise.

### SUMMARY

Apparatuses are disclosed for stochastic interference cancellation. An apparatus, in one embodiment, includes a digital signal processor configured to decode a set of transmitted signals based on a set of received signals. In certain embodiments, a digital signal processor includes a projection module, a stochastic update module, and an interference cancellation module. A projection module, in one embodiment, is configured to update a subset of a set of estimated signals based on error information and on a corresponding subset of mapping information. In certain embodiments, the error information is based on the received signals and the set of estimated signals. In further embodiments, the mapping information indicates how the received signals are affected by the transmitted signals. A stochastic update module, in one embodiment, is configured to adjust the set of estimated signals based on generated noise. An interference cancellation module, in one embodiment, is configured to update the error information based on the adjusted estimated signals. In various embodiments, a projection module, a stochastic update module, and an interference cancellation module may include hardware circuits, programmable hardware circuits and/or executable code. In further embodiments, executable code may be stored on one or more computer readable storage media.

Systems are disclosed for stochastic interference cancellation. A system, in one embodiment, includes a plurality of receive antennas that receive a set of signals. In a further embodiment, a system includes digital signal processing circuitry that decodes a set of transmitted signals based on the set of received signals. In a certain embodiment, the digital signal processing circuitry updates a subset of a set of estimated signals based on error information and on a corresponding subset of mapping information. In a further embodiment, the error information is based on the received signals and the set of estimated signals. In one embodiment, the mapping information indicates how the received signals are affected by the transmitted signals. In a certain embodiment the digital signal processing circuitry adjusts the set of estimated signals based on generated noise. In a further embodiment, the digital signal processing circuitry updates the error information based on the adjusted estimated signals.

Methods are disclosed for stochastic interference cancellation. A method, in one embodiment, includes updating a subset of a set of estimated signals based on error information and on a corresponding subset of mapping information. In a certain embodiment, the error information is based on a set of received signals and the set of estimated signals. In a further embodiment, the mapping information indicates how the received signals are affected by the transmitted signals. A method, in a certain embodiment, includes adjusting the estimated signals based on generated noise. In a further embodiment, a method includes updating the error information based on the adjusted estimated signals.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a multiple-input multiple-output (MIMO) system;

FIG. 2 is a schematic block diagram illustrating one embodiment of a digital signal processor;

FIG. 3 is a schematic block diagram illustrating another embodiment of a digital signal processor;

FIG. 4 is a schematic flow chart diagram illustrating one embodiment of a method for stochastic interference cancellation; and

FIG. 5 is a schematic flow chart diagram illustrating another embodiment of a method for stochastic interference cancellation.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware circuits or devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

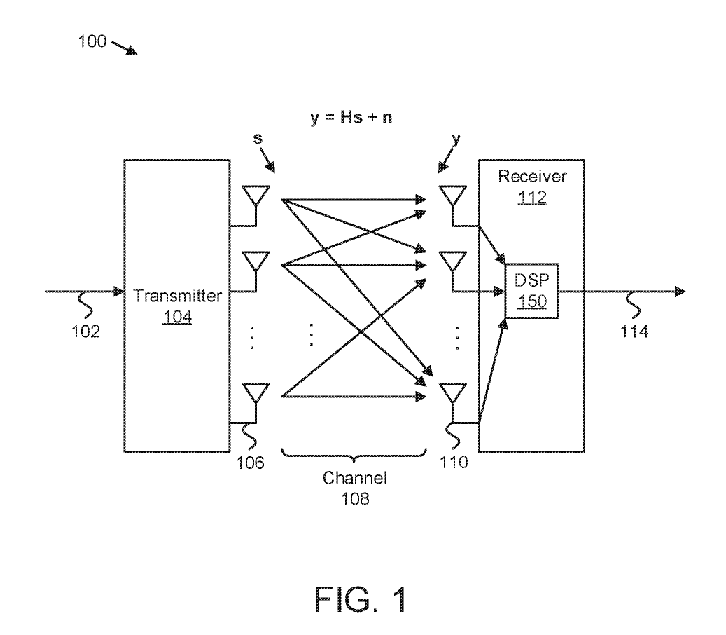

FIG. 1 depicts one embodiment of a multiple-input multiple-output (MIMO) system 100. In the depicted embodiment, the MIMO system 100 includes a transmitter 104 with a plurality of transmit antennas 106, and a receiver 112 with a plurality of receive antennas 110. Data flow in the MIMO system 100 is represented by arrows in FIG. 1. In general, in various embodiments, a transmitter 104 produces a signal or set of transmitted signals, and a receiver 112 receives the signals.

A “signal,” in various embodiments, may refer to any time-varying physical property that conveys information, such as a time-varying voltage or current, a modulated electromagnetic wave in the radio spectrum, a modulated electromagnetic wave in the optical spectrum, or the like. Information and signals may be represented using any of a variety of different technologies and techniques. For example, data, instructions, commands, information, signals, bits, symbols, and the like may be represented by voltages, currents, electromagnetic waves, magnetic fields or particles, optical fields or particles, or any combination thereof. Some drawings herein may illustrate signals as a single signal for clarity of presentation and description. However, it will be understood that an illustration or description herein of a signal may represent multiple signals or a bus of signals, of a variety of bit widths. The present disclosure may be implemented on any number of data signals.

In the depicted embodiment, the signals are radio signals produced by the transmitter 104 using the transmit antennas 106, and received by the receiver 112 using receive antennas 110. Transmit antennas 106 may convert electrical current or voltage signals from the transmitter 104 to radio wave signals, and receive antennas 110 may convert received radio wave signals to electrical current or voltage signals processed by the receiver 112.

In another embodiment, however, signals may be signals other than radio signals that are transmitted and received by multiple components other than antennas 106, 110. More generally, a “channel” 108 that conveys the transmitted signals may include any physical transmission medium or set of media. For example, a channel 108 may be a radio-frequency channel for radio signals, or may include one or more metal wires, fiber optic cables, or the like for electrical or optical signals. Although a wireless transmitter 104 and receiver 112 for transmitting radio signals via a radio frequency channel are depicted in FIG. 1, an apparatus, system, or method for stochastic interference cancellation may be used with a variety of other types of transmitters 104, receivers 112, signals, and channels 108, that transmit and receive signals using antennas 106, 110, or using analogous components for producing and detecting signals other than radio waves.

In the depicted embodiment, the transmitter 104 receives data 102, and produces a set of transmitted signals based on the received data 102. The transmitter 104 may include various components for encoding, transforming, interleaving, and/or modulating the data, which are omitted from FIG. 1 for clarity in describing stochastic interference cancellation. For example, a transmitter 104 may include (or omit) an error-correcting code (ECC) encoder that adds redundant bits to the data 102, an interleaver that changes the order of bits, a mapper that maps bits to amplitudes and/or phases of carrier waves (e.g., by mapping bits to symbols of a quadrature amplitude modulation (QAM) or phase shift keying (PSK) constellation), an orthogonal frequency-division multiplexing (OFDM) modulator that modulates a set of orthogonal sub-carrier frequencies based on the mapped symbols, or the like. Various other or further components for transforming data 102 to a set of signals may be included in or omitted from a transmitter 104.

Conversely, a receiver 112 may include various components for demodulating, de-interleaving, reverse transforming, and/or decoding signals to produce output data 114, which are similarly omitted from FIG. 1 for clarity in describing stochastic interference cancellation. For example, a receiver 112 may include (or omit) a demodulator, a de-interleaver, an ECC decoder, or the like. Various filters, equalizers, and other or further components for transforming signals to data 114 may be included in or omitted from a receiver 112, but may be omitted from FIG. 1 for clarity.

Components of the MIMO system 100 are designated herein as a transmitter 104 and a receiver 112 for convenience in describing the flow of signals and data. However, in certain embodiment, a MIMO system 100 may include transceivers that are capable of both transmitting and receiving. For example, in MIMO wireless telephony, a phone may function as a transmitter 104 to transmit signals to a cellular base station and as a receiver 112 to receive signals from the base station.

The channel 108 may affect the signals as they are conveyed between the transmitter 104 and the receiver 112. Thus, the received signals (represented by the vector y) may differ from the transmitted signals (represented by the vector s). For example, as a signal is transmitted over a channel 108, the signal may be subject to attenuation, delay, noise, and/or interference.

In a single-input, single-output (SISO) system where a transmitter 104 produces one signal (e.g., via one transmit antenna 106) and a receiver 112 receives one signal (e.g., via one receive antenna 110), effects of the channel 108 on the signal may be modeled by:

y=hs+n (1)

In the above equation y is the received signal and s is the original transmitted signal corresponding to a mapped bit-vector. In certain embodiments, a mapped bit-vector may be a symbol in a QAM constellation, a PSK constellation, or the like. Accordingly, the terms “symbol” and “signal” may be used interchangeably herein with the understanding that physical signals or their mathematical representations correspond to or represent data symbols. The signals y and s in the above equation are frequency-domain representation of the transmitted signals, and may be complex-valued functions of frequency so that y(f) for frequency f is a complex number indicating an amplitude and phase for a carrier or sub-carrier wave of frequency f. For example, y and s may be Fourier-transformed versions of time-varying transmitted and received signals.

In the above equation, h is a complex value with amplitude and phase that represent the attenuation and delay of the signal moving from transmitter 104 to receiver 112 through the channel 108, and n is simple additive white Gaussian noise (AWGN) with variance σₙ² per real and imaginary component. Thus, the above equation represents that a received signal is based on a transmitted signal subject to attenuation, delay, and noise.

In a MIMO system 100, the transmitter 104 transmits multiple signals (e.g., via multiple transmit antennas 106), and the receiver 112 receives multiple signals (e.g., via multiple receive antennas 110). In FIG. 1, the connecting arrows between the transmit antennas 106 and the receive antennas 110 represent a multipath signal having complex elements of signal strength and phase delay. The simple SISO model with one transmit antenna and one receive antenna may be expanded to a MIMO model by constructing vectorized representations of the variables with y and n being column vectors of size Nᵣ×1, H being a matrix of size Nᵣ×Nₜ, and s being a column vector of size Nₜ×1, where Nₜ is the number of transmit antennas 106 (or other components for transmitting multiple signals) and Nᵣ is the number of receive antennas 110, (or other components for receiving multiple signals), to arrive at:

y=Hs+n (2)

In Equation 2, elements of y and s are complex values in the frequency domain, with amplitude and phase components representing amplitude and phase for frequencies as described above with reference to Equation 1, and elements of H and n are similarly complex-valued with elements of the channel matrix H representing the attenuation and delay between each pair of transmit antennas 106 and receive antennas 110 (or other components for transmitting and receiving multiple signals), and the noise vector n being multivariate additive white Gaussian noise (AWGN) with independent elements each with variance σₙ² per real and imaginary component.

In one embodiment of a MIMO system 100, the number of transmit antennas Nₜ is equal to a number of complex data streams Nₛ, and each data stream may be encoded into one transmitted signal. In another embodiment, the number of transmit antennas Nₜ may differ from a number of complex data streams Nₛ, and the above equation may be generalized without limitation by making s size Nₛ×1 and H size Nᵣ×Nₛ which includes the combined effects of the Nᵣ×Nₜ channel and an Nₜ×Nₛ stream mapping matrix. For simplicity, we will henceforth continue assuming Nₜ=Nₛ without loss of generality. Additionally, in certain embodiments, where the number of transmit antennas Nₜ is equal to a number of receive antennas Nᵣ, the unscripted number N may be used where N=Nₜ=Nᵣ.

Elements hᵢⱼ of the channel matrix H, in various embodiments, indicate how the i^{th} received signal yᵢ is affected by the j^{th} transmitted signal sⱼ, after attenuation and delay. For example, a diagonal channel matrix H would represent that each transmitted signal sᵢ was received only by a corresponding receive antenna 110 as a received signal yᵢ, meaning that the channel 108 in some way prevented signals from mixing (e.g., if signals were conveyed by separate wires rather than wirelessly). Such a case would be equivalent to multiple non-overlapping SISO signals, and the signals could be processed as in the SISO case, without accounting for mixing of signals or inter-signal interference.

Conversely, in the depicted MIMO system 100 the i^{th} received signal yᵢ is affected by multiple transmitted signal sⱼ, and the channel matrix H has significant non-zero off-diagonal terms. Thus, where Equation 1 represents that a received signal in a SISO system is based on a transmitted signal subject to attenuation, delay, and noise, Equation 2 represents that multiple received signals in a MIMO system 100 are based on the transmitted signals, subject to attenuation, delay, noise, and interference or mixing of the transmitted signals. A MIMO decoder, such as the digital signal processor 150 described below, may receive signals from multiple receive antennas 110, where the received signals are based on transmitted signals from multiple transmit antennas 106, and on channel effects such as attenuation, delay, mixing or interference (indicated by H) and/or noise (indicated by n). The MIMO decoder may decode or estimate the transmitted signals based on the received signals.

In the depicted embodiment, the receiver 112 includes a digital signal processor (DSP) 150. The term “digital signal processor” as used herein, may refer to circuitry that receives signals (e.g., the signals received and converted to electrical voltages or currents by the receive antennas 110), and processes the signals to output data 114. For example, in certain embodiments, the DSP 150 may estimate or decode a set of transmitted signals s based on a set of received signals. In further embodiments, a DSP 150 may perform other or further transformations such as error correction, de-interleaving, or the like, as described above to output data 114. In one embodiment, a digital signal processor 150 may be a general-purpose processor that executes code stored on a computer-readable storage medium (e.g., a memory) for processing signals. In another embodiment, a DSP 150 may be a special-purpose processor with an instruction set adapted for signal processing, and may execute code stored on a computer-readable storage medium (e.g., a memory) for processing signals. In further embodiments, a DSP 150 may include one or more hardware circuits or programmable hardware circuits or devices. For example, a DSP 150 may be, or may include, an application-specific integrated circuit, a field programmable gate array, or the like.

An application for stochastic interference cancellation, in various embodiments, may include a DSP 150. Similarly, a system for stochastic interference cancellation may include a plurality of receive antennas 110 that receive a set of signals, and may include digital processing circuitry such as a DSP 150. In certain embodiments, a DSP 150 may be configured to perform a method for stochastic interference cancellation, as disclosed herein.

In the depicted embodiment, the DSP 150 is configured to decode a set of transmitted signals based on a set of received signals. The term “set” as used herein, may refer to a collection of one or more things. For example, a set of signals is a collection of one or more signals, a set of bits is a collection of one or more bits. Sets or collections of information or signals may be represented as vectors, matrices, and the like herein for convenience in describing operations of the DSP 150, without regard to how the data, information or signals are stored or processed. For example, a set of received signals is represented herein as a received signal vector y and a set of transmitted signals is represented herein as a transmitted signal vector s, without any implication as to whether elements of the received signal vector y are stored in contiguous or non-contiguous locations, processed in parallel or in sequence (e.g., using vector processing or scalar processing), or the like. Decoding a set of transmitted signals may refer to determining, detecting, or estimating the transmitted signals, based on the received signals.

Accordingly, a DSP 150 used to process received MIMO signals may be referred to as a “detector.” At times, the detector may also be referred to as a “decoder,” not to be confused with a decoder for an error-correcting code (ECC), which may be referred to herein as an “ECC decoder.” A DSP 150 in an apparatus for stochastic interference cancellation may also be referred to herein as a “stochastic interference canceler” (STIC).

In various embodiments, the DSP 150 may receive or determine channel state information. Channel state information may be any information about properties or conditions of the channel 108, and how the channel affects signals. For example, when the transmitter 104 sends a data packet, it may include a training sequence or preamble of predetermined signals, and the DSP 150 may determine how factors such as attenuation, delay, noise, and/or interference in the channel 108 affect the received signals, by comparing the received signals to the known or predetermined transmitted signals. Thus, with reference to the channel model y=Hs+n, channel state information may include information about, or estimates of, the channel matrix H and the statistical information of the noise vector n. The channel matrix H may represent properties of the channel 108 that are at least temporarily consistent, such as attenuation and delay, and the statistical information of the noise vector n may represent inconsistent or random variations noise. The DSP 150 may determine or estimate elements of the channel matrix H, which represent attenuation, delay, and mixing of signals, based on the received training signals. Similarly, although the value of the noise vector n may be different for signals sent at different times in the training sequence, the DSP 150 may determine information about the noise vector n, such as a variance

The term “mapping information” is used herein to refer to information that indicates how received signals y are affected by transmitted signals s, or equivalently, how the different components of the transmitted signals s contribute (after attenuation, delay, and mixing or interference between signals) to the components of the received signals y. Mapping information may include the channel matrix H, or information in the channel matrix H, such as elements or columns of the H. The term “noise information” may be used to refer to information about how the received signals y are affected by factors other than the transmitted signals s. For example, noise information may include information about the noise vector n, such as a variance σₙ², an average energy, or the like.

In general, in various embodiments, the DSP 150 may decode or estimate transmitted signals from the received signals by using mapping information such as the channel matrix H. However, certain columns of H may be nearly parallel. With regard to columns of H, the channel model y=Hs+n may be represented in vector form as y=s₀h₀+s₁h₁+s₂h₂+ . . . n, where hᵢ is the i^{th} column of the channel matrix H, indicating how the i^{th} transmitted signal sᵢ contributes to the total received signal vector y. Some columns hᵢ and hⱼ of H may be closer to parallel than to orthogonal, particularly if signals from nearby or otherwise similar transmit antennas 106 are received with similar attenuation and delay by the receive antennas 110. Two nearly-parallel columns of H may indicate that two transmitted signals are transformed by the channel 108 and contribute to the total received signal y in similar ways, and that it may therefore be difficult to separate or distinguish those signals at the receiver 112.

In certain embodiments, the DSP 150 may decode or estimate transmitted signals from the received signals using successive interference cancellation. Successive interference cancellation (SIC) is a general technique useful in many situations where multiple signals are present and it is desirable to estimate at least one of these signals accurately. The secondary signals could be unintentional signals such as when using spread-spectrum coding, undesirable self-interference such as inter-symbol interference (ISI) or OFDM inter-carrier interference (ICI), purposefully overlapping signals such as in spatial-multiplexing MIMO, or another form of interference or colliding transmission. Regardless of the cause of the multiple signals, if they can be estimated then they can be successively canceled with a SIC for potentially improved system performance.

The general idea in a SIC is to first estimate one of the signals (generally the strongest), then subtract (i.e. cancel) the effects of estimated transmitted signal from the original received signal, and repeat on successive signals until they are sufficiently estimated. Note that under some situations it is useful to iterate the technique, potentially in different orders, and potentially while considering additional side information such as what may be output from an error correction decoder.

Additional details on SIC are described in Cover et al., Broadcast channels, IEEE Trans. Inf. Theory, vol. 18, no. 1, pp. 2-14 (1972); Wolniansky et al., V-BLAST: An architecture for realizing very high data rates over the rich-scattering wireless channel, IEEE International Symposium on Signals, Systems, and Electronics (1998); Tarokh et al., Combined array processing and space-time coding, IEEE Trans. Commun., vol. 45, no. 4, pp. 1121-1128 (1999); and Miridakis et al., A survey on the successive interference cancellation performance for single-antenna and multiple-antenna OFDM systems, IEEE Communications Surveys & Tutorials, vol. 15, num. 1, pp. 312-335 (2013); the disclosure of each which is hereby incorporated in its entirety herein by this reference.

In the following sections variations of successive interference cancellation are interference canceler variations primarily under the context of a MIMO detector application, though it should be understood that the general technique can be used in many variations with this and other similar signal processing applications.

In certain embodiments, a DSP 150 may repeatedly estimate transmitted signals, and use the mapping information and the estimated signals to update error information. Estimates of the transmitted signals may be referred to as a set of “estimated signals” or “signal estimates” herein, with the implication that the received signals are known, and that the estimation process refers specifically to the transmitted symbols. A set of signals that estimate or correspond to the actual (but unknown at the receiver 112) transmitted signals may be represented herein by a vector ŝ, or by individual elements ŝᵢ corresponding to individual received signals sᵢ. Additionally, the term “estimate” may be used for the vector ŝ, or for individual elements ŝᵢ regardless of how well the vector ŝ, or elements ŝᵢ actually approximate the transmitted signals s at any given time. For example, the DSP 150 may initialize a signal estimate ŝ to be a zero vector, and iteratively refine the signal estimates ŝ to more closely approximate the transmitted signals s over time, but the initialized zero-valued ŝ may still be referred to as a set or vector of estimated signals.

In certain embodiments, the DSP 150 may determine or calculate error information. The “error information” may be used herein to refer to information based on the actual received signals and the set of estimated signals. For example, the DSP 150 may use mapping information such as the channel matrix H to determine or estimate how the estimated transmitted signals ŝ would affect or contribute to the actual received signals y, and the error information may include information about differences between the actual received signals y and the expected contribution Hŝ of the signal estimates ŝ would to the received signals. For example, the error information may be an error vector e=y−Hŝ. Error information e may initially be equal to the received signals y if signal estimates ŝ are initialized to zero.

A DSP 150 may use mapping information to such as the channel matrix H to iteratively update signal estimate ŝ and error information e. For example, the DSP 150 may estimate stronger signals, subtract the effects of the stronger signals from the received signals or error information, and then estimate weaker signals based on the updated error information. However, successively estimating signals based on error information may be difficult in both single-user multiple-input multiple-output (SU-MIMO) and multi-user MIMO (MU-MIMO) wireless communications, also known as spatial multiplexing MIMO, where there are multiple signals with low and/or similar signal to interference and noise ratios (SINR). At times, a signal processor may become trapped in cycles, or near local minima for the error vector e, where further updates to the estimate ŝ and the error vector e based on the mapping information H fail to further minimize the error vector. In some such circumstances, a signal processor may fail to determine a signal estimate ŝ that can be decoded by an error-correcting code decoder. Failure to produce a usable signal estimates ŝ in certain situations may result in limited usable range between the transmitter 104 and the receiver 112, limited data speeds between the transmitter 104 and the receiver 112, or the like.

In the depicted embodiment, however, the DSP 150 is configured to perform stochastic interference cancellation. In general, in various embodiments, a DSP 150 performing stochastic interference cancellation may update one or more signal estimates (e.g., components of the signal estimate vector ŝ), based on the error information e and on the mapping information H, adjust the estimated signals based on generating noise, and update the error information based on the adjusted (noisy) estimated signals. In certain embodiments, a DSP 150 may adjust signal estimates with generated noise by adding noise to the error information e prior to updating the signal estimates, or by adding noise directly to the signal estimates.

In effect, adding noise to the error information or the signal estimates may involve purposefully selecting a “wrong” answer: an updated signal estimate is first determined based directly on the mapping information, and is then adjusted in a random direction, without knowing whether the adjustment takes the signal estimate closer to or further away from the actual transmitted signal. However, in certain embodiments, adjusting signal estimates with generated noise may prevent the DSP 150 from stalling in cycles or near local minima or for the error vector e, and/or may result in the DSP 150 producing a suitably accurate (e.g., correct or ECC-decodable) signal estimate in fewer iterations than a DSP that performs interference cancellation without stochastic adjustments. Thus, in certain embodiments, a DSP 150 configured to perform stochastic interference cancellation may decode transmitted signals with less power consumption and/or lower latency than a non-stochastic DSP. In certain embodiments, stochastic interference cancellation may improve the performance of a DSP 150 while reducing cost, latency, error propagation, and/or noise amplification.

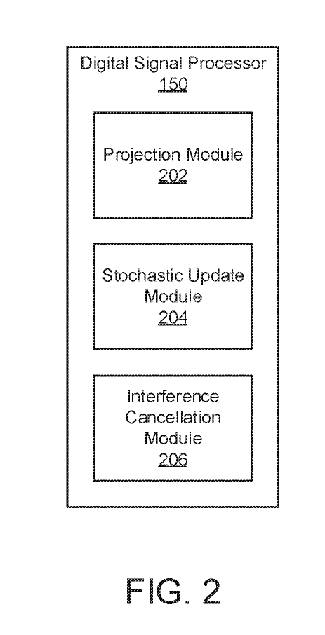

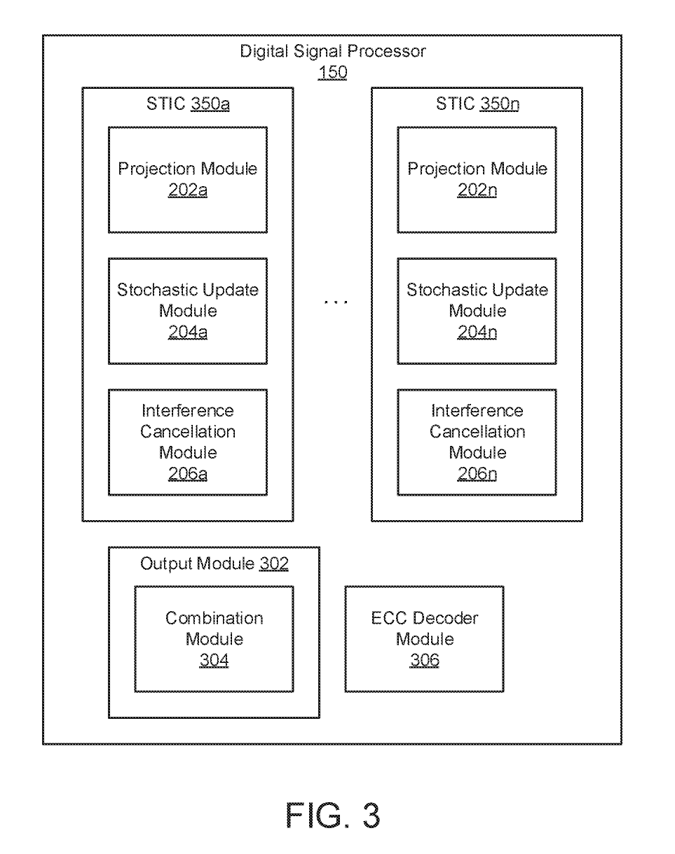

A DSP 150 for stochastic interference cancellation is described in further detail below with reference to FIGS. 2 and 3.

In the previous discussion the system/channel model y=Hs+n (Eq. 2) has been described in a complex-valued form. However, the model thus defined can be in either a complex or real form without loss of generality, therefore an equivalent real version may be defined as:

$$\begin{matrix}{H}_{r} = [ \begin{matrix} \{ H \} & - \{ H \} \\ \{ H \} & \{ H \}\end{matrix} ] & ( 3 ) \\ {y}_{r} = [ \begin{matrix} \{ y \} \\ \{ y \}\end{matrix} ] & ( 4 ) \\ {s}_{r} = [ \begin{matrix} \{ s \} \\ \{ s \}\end{matrix} ] & ( 5 ) \\ {n}_{r} = [ \begin{matrix} \{ n \} \\ \{ n \}\end{matrix} ] & ( 6 ) \\ {y}_{r} = {H}_{r} {s}_{r} + {n}_{r} & ( 7 )\end{matrix}$$

where [symbol] and [symbol] extract the real and imaginary components, respectively. Note that this structure of the real matrix Hᵣ results in orthogonal columns at column indices i and i+Nₜ, for i<Nₜ. For simplicity, the real form will hereafter be used without the additional subscripted notation. If the complex form is used, operations described below for real-valued vectors and matrices may be replaced by analogous operations for complex-valued vectors and matrices For example, the operations described below involving a the transpose (e.g., H^{T}) of a real-valued matrix or vector may be replaced by analogous operations involving the Hermitian conjugate transpose (e.g., H^{H}) if the complex form is used.

Additionally, although apparatuses, systems, and methods for stochastic interference cancellation are disclosed herein with reference to the MIMO system 100 of FIG. 1, the disclosed apparatuses, systems, and methods can be applied to many signal processing systems including single-user MIMO (SU-MIMO), multi-user MIMO (MU-MIMO), multi-user systems and networks, orthogonal frequency-division multiplexing (OFDM), orthogonal frequency-division multiple access (OFDMA), spread-spectrum, code-division multiple access (CDMA), and others where the system includes multiple estimable signals which interfere with each other. Apparatuses, systems, or methods for stochastic interference cancellation may also be used to solve other problems mathematically analogous to the problem of decoding or estimating transmitted symbols based on received signals and mapping information, such as integer least squares problems, and lattice problems, regardless of whether such problems actually involve transmitted and received signals.

FIG. 2 depicts one embodiment of a digital signal processor 150. The DSP 150 may be substantially as described above with reference to FIG. 1, and may be configured to decode a set of transmitted signals based on a set of received signals. In the depicted embodiment, the DSP 150 includes a projection module 202, a stochastic update module 204, and an interference cancellation module 206, which are described below.

The projection module 202, in the depicted embodiment, is configured to update a subset of a set of estimated signals based on error information and on a corresponding subset of mapping information. The set of estimated signals may be represented as a vector ŝ, or by individual elements corresponding to individual received signals sᵢ, as described above with reference to FIG. 1. Where the term “set” herein refers to a collection of one or more things (e.g., signals), the term “subset” may be used with reference to a set to refer to one or more elements from the set. Thus, a subset may include one, some, or all of the elements of a set (e.g., a subset may or may not be a proper subset). Similarly, a subset of the estimated signals ŝ may include one, some or all of the components ŝ of the total estimated signal vector ŝ.

Error information is described above with reference to FIG. 1, where the error information is based on the actual received signals and the set of estimated signals. For example, error information may refer to an error vector e=y−Hŝ, or components of the error vector. Mapping information is similarly described above where the mapping information indicates how the received signals are affected by the transmitted signals. For example, mapping information may refer to the channel matrix H, to one or more columns hᵢ of the channel matrix H, one or more elements Hᵢⱼ of the channel matrix H, or the like.

In certain embodiments, a subset of the mapping information may correspond to a transmitted signal, or to an estimated transmitted signal. Recalling that the channel model y=Hs+n may be represented in vector form as y=s₀h₀+s₁₁+s₂h₂+ . . . n, where hᵢ is the i ^{th} column of the channel matrix H, a column hᵢ indicates how the i^{th} transmitted signal sᵢ affects or contributes to the total received signal vector y. Accordingly, mapping information that corresponds to the i^{th} transmitted signal sᵢ or to the i^{th} estimated (transmitted) signal ŝ may be the i^{th} column hᵢ of the channel matrix H.

In various embodiments, the projection module 202 updates a subset of signal estimates based on a corresponding subset of mapping information. The “corresponding subset” of mapping information, in various embodiments, may be the mapping information that corresponds to the subset of signal estimates that the projection module 202 updates. For example, if the projection module 202 updates the first, third and fourth signal estimates, the corresponding subset of mapping information would include the first, third, and fourth columns of H. Similarly, if the projection module 202 updates one or all the signal estimates, the corresponding subsets of mapping information would be, respectively, a single column of H, or all the columns of H.

In various embodiments, “updating” an estimated signal, a subset of the estimated signals, or the set of estimated signals based on mapping information may refer to modifying an existing signal estimate or set of signal estimates based on mapping information, or may refer to determining an initial estimate or set of signal estimates based on mapping information (in which case the “update is from not having a signal estimate to having one). An initial signal estimate may also be zero, or may be a signal estimate from another source such as an ECC decoder or another MIMO decoder.

Additionally, updating an estimated signal, a subset of the estimated signals, or the set of estimated signals may be referred to as “based on” information such as error information and mapping information if the projection module 202 uses at least a portion of the information upon which the update is “based on” to determine the updated estimated signal(s). For example, an update may be described as “based on” mapping information if the projection module 202 uses at least a portion of the mapping information to determine the update. More generally, processes herein are described as being “based on” certain types of information, where the term “based on” indicates that at least a portion of the information is used in, or as a basis for, the process.

Various algorithms or steps used by the projection module 202 to update a subset of the estimated signals are described below. One approach that may be used by the projection module 202 to update estimated signals is to use projection. Recalling that the channel model y=Hs+n is represented in vector form as y=s₀h₀+s₁h₁+s₂h₂+ . . . n, using a dot product (or a corresponding inner product for complex-valued vectors) to project the received signal vector y onto one of the columns hᵢ may provide an estimate ŝ of the corresponding transmitted signal sᵢ. Specifically, the projection module 202 may first project the i^{th} column of the channel H, designated hᵢ, against the received signal y, to generate an estimate ŝ of the i^{th} transmitted symbol sᵢ.

$${\hat{s}}_{i} = \frac{{h}_{i}^{T} y}{{h}_{i}^{T} {h}_{i}} = {s}_{i} + {\sum }_{j , i \neq j} \frac{{h}_{i}^{T} {h}_{j}}{{h}_{i}^{T} {h}_{i}} {s}_{j} + \frac{{h}_{i}^{T} n}{{h}_{i}^{T} {h}_{i}} \qquad ( 8 )$$

The error information e (initially y if the estimated signals ŝ are initialized to zero) may be updated (e.g., by an interference cancellation module 206 as described below) by cancelling out the expected effects of the signal estimate ŝᵢ as follows:

e=y−ŝᵢhᵢ. (9)

This procedure is repeated with additional projections against the updated/residual error vector until no more estimable signals remain, as in ŝₖ=hₖ^{T}e/hₖ^{T}hₖ. Notice that this approach will only work well when the hᵢ^{T}hⱼsⱼ cross terms are small. If the columns of H are orthogonal, then projection onto one of the columns hᵢ may effectively pick out the signal sᵢ plus a contribution from projecting the noise vector n onto the column hᵢ. However, as discussed above with reference to FIG. 1, certain columns of columns of H may be closer to parallel than to orthogonal. Thus, non-zero or large hᵢ^{T}hⱼsⱼ cross terms may result in the estimated signal ŝᵢ being significantly different from the actual transmitted signal sᵢ, and in the error vector e including significant errors. Additional projections onto other columns of H may introduce new errors from new hᵢ^{T}hⱼsⱼ cross terms, and may propagate the errors that are already in the error vector e. The impact of these error terms is referred to as error propagation and is one of the main limiting features of interference cancellation. In the spatial-multiplexing MIMO context the cross terms have significant energy and the signals have similar energy distributions. Therefore, projection onto individual columns of H appears to be a poor choice in the MIMO context. However, with the addition of stochastic adjustments as described below, a projection module 202 may update individual signals ŝᵢ based on individual columns hᵢ.

Another approach that may be used by the projection module 202 to update estimated signals is to project the received signal vector y (or the error vector e that remains after previous estimates) onto all the columns of H at once. A “zero forcing” (ZF) algorithm for the projection module 202 first makes a ZF estimate of all symbols as in

ŝ=H^{t}y=s+H^{t}n (10)

where H^{†}=(H^{T}H)⁻¹H^{T} is the Moore-Penrose pseudoinverse of H. Just as left-multiplying the received signal vector y by a single transposed column hᵢ^{T} of H projects the received signal vector onto that column (followed by division by hᵢ^{T}hᵢ to scale the estimated signal ŝᵢ to the correct magnitude), left-multiplying the received signal vector y by the transposed channel matrix H^{T} projects onto all columns of H. This projection using H^{T} transforms the channel model y=Hs+n, giving H^{T}y=H^{T}Hs+H^{T}n. The square matrix H^{T}H has elements hᵢ^{T}hⱼ where the elements on the diagonal indicate the magnitude or the L₂-norm of each column hᵢ, and the off-diagonal elements are dot products or inner products indicating the extent to which different columns hᵢ and hⱼ are cross-correlated or non-orthogonal. Application of the inverse (H^{T}H)⁻¹ may then result in (H^{T}H)⁻¹H^{T}y=s+(H^{T}H)⁻¹H^{T}n, equivalent to H^{t}y=s+H^{t}n, thus transforming the receive signal vector y to produce a symbol estimate ŝ that differs from the actual transmitted signals s by a noise term H^{t}n.

In certain embodiments, an interference cancellation module 206 may select one of the jointly estimated symbols produced by the projection module 202 for cancellation, such as a symbol with the greatest estimated contribution or effect hᵢ^{ŝ}ᵢ on the total received signal y. In another embodiment an interference cancellation module 206 may cancel two or more of the jointly estimated symbols produced by the projection module 202 simultaneously, resulting in a residual error vector e=y−Σhᵢŝᵢ (summed over signal indices for the signals that have been selected for cancellation).

The projection module 202 in a subsequent iteration may repeat the ZF estimation on the residual error vector e, using a modified pseudoinverse (H′)^{t} where the matrix H′ is a ‘deflated’ version where the previously canceled i^{th} columns have been removed. For more information see Miridakis et al., “A survey on the successive interference cancellation performance for single-antenna and multiple-antenna OFDM systems,” IEEE Communications Surveys & Tutorials, pp. 312-335 (2013).

However, the noise term H^{t}n may be significant. If columns of H are close to parallel, elements of H^{t} may be large, and the noise term H^{t}n in the estimated signal vector ŝ may be similarly large. A projection module 202 that updates signal estimates using H^{t} may cause significant noise-enhancement in addition to error-propagation problems. To help mitigate this issue, a projection module 202 may use a modified or regularized pseudo-inverse for updating signal estimates. For example, the zero-forcing pseudo-inverse matrix

W_{ZF}=H^{t}=(H^{T}H)⁻¹H^{T} (11)

may be replaced with a minimum-mean-sauare-error (MMSE) variant

$${W}_{MMSE} = {( {H}^{T} H + \frac{{σ}_{n}^{2}}{𝔼 ( {\vert s \vert}^{2} )} I )}^{- 1} {H}^{T} \qquad ( 12 )$$

where σₙ² is the noise variance of the elements of n and [symbol] (|s|²) is the average energy of a transmitted symbol, i.e., an element of s. Effectively, the square matrix H^{T}H is modified by increasing elements on the diagonal to prevent the inverse of the adjusted H^{T}H from becoming too large. The adjustment may be greater when noise is highly varied or signals are weak, and smaller when signals are strong or noise is less highly varied. A projection module 202 using the MMSE variant may reduce noise enhancement, but at the cost of higher implementation complexity. Additionally, some residual inter-symbol interference among the elements of s may occur because adjusting H^{t} to reduce the noise enhancement may also reduce the estimated signals.

Another approach that may be used by the projection module 202 and the interference cancellation module 206 to update estimated signals and cancel their contributions to the error vector is to estimate a subset of the transmitted signals and cancel their effects at each step. This may involve projecting using a single column of H for a single signal ŝᵢ, or projecting based on all the columns of H together to produce a full set of jointly estimated signals ŝ (both of which are described above), or, in some embodiments, may include jointly estimating two or more, but less than all, of the transmitted signals.

In certain embodiments, a projection module 202 that jointly estimates some of the transmitted symbols may be useful if decoding of signals is latency constrained (e.g., for telephonic communication or similar applications where longer delays are not acceptable to users), or if none of the signals are clearly stronger than the others, meaning that there is no clear choice of which signals to estimate first.

In certain embodiments, the projection module 202 may update a subset of signal estimates described by a set [symbol] , where [symbol] is a set of indices. For example, if the projection module 202 updates the signal estimates ŝ₁, ŝ₃, and ŝ₄, then the set [symbol] , which describes the subset of signal estimates, may be the set {1, 3, 4}. Subscripts herein involving the [symbol] notation refer to indices in the set. Thus, we define the notation

$$\begin{matrix}{\hat{s}}_{𝒜} = [ \begin{matrix}{\hat{s}}_{{a}_{0}} \\ ⋮ \\ {\hat{s}}_{{a}_{M - 1}}\end{matrix} ] & ( 13 ) \\ {G}_{𝒜} = [ \begin{matrix}{h}_{{a}_{0}} & ⋯ & {h}_{{a}_{M - 1}}\end{matrix} ] & ( 14 )\end{matrix}$$

where [symbol] is the set of M symbol indexes {a₀, . . . , a_{M-1}} and the corresponding M column indexes of H are included in a current projection step for the projection module 202. For example, if [symbol] is the set {1, 3, 4} of indices 1, 3, and 4, [symbol] is a vector of size three containing only the signal estimates ŝ₁, ŝ₃, and ŝ₄, and [symbol] is a matrix of width three, equal to [h₁ h₂ h₄].

In further embodiments, the projection module 202 may update the subset of estimated signals with indices in [symbol] (e.g., [symbol] ), based on the error information error e, and on columns of H with indices in [symbol] (e.g., [symbol] ). Thus, the matrix [symbol] is a subset of the mapping information (e.g., the channel matrix H), corresponding to the subset of signal estimates that the projection module 202 updates.

The projection module 202 may update the subset of estimated signals [symbol] as follows:

$${\hat{s}}_{𝒜} = {( {G}_{𝒜}^{T} {G}_{𝒜} )}^{- 1} {G}_{𝒜}^{T} ( y - {\sum }_{k} {h}_{k} {\hat{s}}_{k} ) = {G}_{𝒜}^{†} e \qquad ( 15 )$$

where interference from the prior ŝₖ symbol estimates has been cancelled out of the error vector e following previous estimates. This generalizes the projection to estimate a set of symbol elements with indexes [symbol] which are jointly solved for. The update defined by Equation 15 may also be referred to as generalized projection. After projection to determine [symbol] , the projection module 202 may update the full set or vector of signal estimates ŝ by adding the components of [symbol] at the indices described by [symbol] , and the interference cancellation module 206 may update the error vector e by subtracting the contributions of the new signal estimates [symbol] , using

$${e}_{new} = e - {\sum }_{{a}_{i} ∈ 𝒜} {h}_{{a}_{i}} {\hat{s}}_{{a}_{i}} . \qquad ( 16 )$$

The projection module 202, the stochastic update module 204 and the interference cancellation module 206 may iterate through multiple steps with multiple sets [symbol] of indices until at minimum all of the symbol indexes have been used. When needed for clarity, we may use the subscript m for [symbol] to indicate the iteration step index, i.e. [symbol] corresponds to the set of symbol indexes we use for the m^{th} projection step.

There are two selections of [symbol] that are equivalent to the single-vector projection or zero-forcing projection processes described above. When [symbol] ={m} with m=0, 1, . . . , 2Nₜ−1, we have the basic projection IC with at minimum 2Nₜ−1 projection steps. When the exhaustive set [symbol] ₀={0,1, . . . , 2Nₜ−1} is used we have a one-step ZF interference canceller.

Recall that projection using a single column of H has the drawback of potentially large error propagation whereas simultaneous projection onto all the columns of H (for ZF interference cancellation) may have large noise-enhancement. By contrast, a projection module 202 that updates a generalized subset of signal estimates based on a generalized subset of the columns of H may allow for greater flexibility, providing a tradeoff between error-propagation (when projecting onto fewer columns of H) and noise-enhancement (when projecting onto more columns of H). The interference cancellation steps may be performed as described in earlier sections.

Additionally, generalized projection IC update in Eq. 15 has been described in the form of a zero-forcing pseudo-inverse, since ( [symbol] )⁻¹ [symbol] = [symbol] . It may also be easily modified for MISE to improve performance for nearly singular selections of [symbol] . This can be done by using the projection matrix

$${G}_{𝒜 , MMSE}^{†} = {( {G}_{𝒜}^{T} {G}_{𝒜} + \frac{{σ}_{n}^{2}}{𝔼 ( {\vert s \vert}^{2} )} I )}^{- 1} {G}_{𝒜}^{T} . \qquad ( 17 )$$

In further embodiments, the projection module 202 may select or determine the set [symbol] of signal indices, the subset [symbol] of signals to jointly estimate, and/or the corresponding subset [symbol] of the mapping information. In one embodiment, the projection module 202 may select index sets [symbol] in multiple iterations so that all the columns of H are used at least once when considering the union of all [symbol] matrices. In certain embodiments, the projection module 202 may select and re-use a small number of [symbol] matrices to reduce the initialization cost of determining multiple [symbol] . Additionally, in some embodiments, projection module 202 may select or determine the set [symbol] to reduce interference in individual stochastic interference cancellation steps and to avoid a nearly singular [symbol] which would lead to noise enhancement.

In one embodiment, with low complexity, the projection module 202 may create a set of [symbol] matrices from single columns of H. In a further embodiment, if a real valued model is constructed from a complex one, then the projection module 202 may use known orthogonal column pairs (corresponding to real and imaginary parts of columns of H) to compute in parallel to reduce latency (equivalent to selecting a single column of a complex-valued H.)

In a certain embodiment, the projection module 202 may use all of the columns of H. This choice has the potential drawback of creating noise-enhancement which may reduce performance (as discussed above). In another embodiment, a projection module 202 may randomly or pseudo-randomly select indices to create a set of [symbol] matrices. In certain embodiments, the projection module 202 may use predetermined sets of indices (e.g., determined based on prior experimentation) or may generate sets of indices as needed before use.

Recalling that updating signal estimates ŝᵢ one at a time based on individual columns hᵢ propagates errors from hᵢ^{T}hⱼsⱼ cross terms, it may be desirable in some embodiments for a projection module 202 to estimate signals based on columns hᵢ and hⱼ simultaneously if a cross correlation hᵢ^{T}hⱼ that would result in error propagation is large. Conversely, a projection module 202 may estimate signals based on columns hᵢ and hⱼ in separate steps if a cross correlation hᵢ^{T}hⱼ that would result in error propagation is small, or zero.

For example, in one embodiment, the projection module 202 may construct [symbol] from columns of H with high cross correlation as identified from large magnitude off-diagonals in H^{T}H. In some embodiments, advance knowledge of antenna placements can be used in pre-selecting the choices of [symbol] , based on the assumption that the highest correlation is between neighboring antennas. One such example of this would be in a linear array of antennas with sequential numbering. In this case [symbol] may be constructed from columns of H with [symbol] ₀={0,1}, [symbol] ₁={3,4}, [symbol] ₂={1,2}, [symbol] ₃={4,5} . . . for a three antenna MIMO system 100. Some of the columns of H may be reused to re-estimate previously estimated signals. In a further embodiment, the projection module 202 may construct [symbol] using triplets of the columns of H.

In another embodiment, the projection module 202 may construct [symbol] by avoiding low cross correlation column combinations. This can be done by noting that in the matrix structure of Hᵣ in Eq. 3, with the notation hᵢ⊥hⱼ indicating that the vectors hᵢ and hⱼ are orthogonal, we have hₜ⊥h_{i+N} for i<Nₜ, which means they have zero cross correlation and should not be combined. For example, in the case of Nₜ=4 and | [symbol] ₘ|=4, we have h₀⊥h₄, h₁⊥h₅, and so on. Then [symbol] may be constructed from columns of H with [symbol] ₀={0,1,2,3}, [symbol] ₁={0,1,6,7}, [symbol] ₂={4,5,2,3}, . . . etc.

Thus, in one embodiment, where the projection module 202 updates a subset [symbol] of a set ŝ of estimated signals, based on error information e and on a corresponding subset [symbol] of mapping information, the subset [symbol] of mapping information may include a single column hᵢ corresponding to a single transmitted signal sᵢ, so that the projection module 202 updates a single signal estimate ŝᵢ. In another embodiment, the subset [symbol] of mapping information may include all the columns of H, corresponding to the full set of transmitted signals s, so that the projection module 202 updates the full set of signal estimates ŝ.

In one embodiment, the subset [symbol] of mapping information may include two or more columns of H, corresponding to two or more transmitted signal sᵢ, so that the projection module 202 updates a subset [symbol] of two or more signal estimates. In one embodiment, the projection module 202 may select the signals to estimate, the corresponding indices, or the corresponding columns of H randomly from the full sets (where the term “randomly” encompasses selection based on actual random information such as detected noise, or pseudo-randomly generated selections). In another embodiment, the projection module 202 may select the signals to estimate, the corresponding indices, or the corresponding columns of H from the full sets based on cross correlations in the mapping information H. The projection module 202 may select indices, signals to estimate, or columns of H (equivalently) based on cross correlations in the mapping information H, by identifying columns of H with high cross correlation from large magnitude off-diagonals in H^{T}H, or by avoiding low cross correlation column combinations such as known orthogonal pairs, both of which are described above.

Additionally, in certain embodiments, the projection module 202 may determine an initial set ŝ of estimated signals. The initial set ŝ of estimated signals, in one embodiment, is a set of zero-amplitude signals, or a zero vector. In another embodiment, the projection module 202 may receive an initial set ŝ of estimated signals from a source external to the projection module 202, the stochastic update module 204, and the interference cancellation module 206. For example, the projection module 202 may receive an initial set ŝ of estimated signals from another MIMO decoder, from an LDPC decoder, or the like. In some embodiments, a finite set of possible valid signals may be defined for a transmission. For example, transmitted signals may be from a QAM or PSK constellation. In further embodiments, the projection module 202 may select the initial set ŝ of estimated signals from the finite set of possible valid signals. For example, the projection module 202 may randomly generate initial signal estimates from a QAM constellation, or may select symbols from a QAM constellation on a predetermined basis to provide a diverse set of initial signal estimates. In further embodiments, the projection module 202 may determine initial values for the error information e corresponding to the initial estimated signal set ŝ by setting e=y−Hŝ.

In certain embodiments, the projection module 202 uses a QR-decomposition to simplify many of the calculations. This is done by first solving H=QR. After applying Q^{T} to y and H, the calculations using columns of H to construct [symbol] may be reduced in size by using the upper triangular R. Note that this may be used in conjunction with limiting the interference cancellation to only a subset of e corresponding to the non-zero portion of the R columns used in constructing [symbol] . Many other factorizations for the matrix H may be used to potentially lower the complexity beyond QR-decomposition. Some of these may include LU-factorization, Cholesky factorization, or singular value decomposition (SVD).

The stochastic update module 204, in certain embodiments, is configured to adjust the set of estimated signals produced by the projection module 202, based on generated noise. The processes described above for the projection module 202, to update estimated signals based on projection, are deterministic once the projection module 202 has initialized the estimated signal set ŝ, the error vector e, and has selected the index sets [symbol] . Once those parameters of the process are set, the projection module 202 proceeds deterministically. By contrast, the stochastic update module 204 is configured to introduce randomness into the process, from generated noise.

The stochastic update module 204 “adjusting” the estimated signals produced by the projection module 202, in various embodiments, may refer to any process producing a stochastic, noisy, or partially random estimated signal, regardless of whether the projection module 202 actually produced a deterministic estimate. For example, in one embodiment, the projection module 202 may produce a deterministic signal estimate, and the stochastic update module 204 may adjust the signal estimate by adding a stochastically determined change. In another embodiment, however, the stochastic update module 204 may “adjust” a signal estimate before it has been produced by the projection module 202, by injecting stochastic changes into the information used by the projection module 202 (e.g., into the error information e). The resulting stochastic estimate may be referred to as an “adjusted” estimate even though a deterministic estimate was not produced prior to the adjustment.

Additionally, adjusting the set of estimated signals, in various embodiments, may include adjusting one, some or all of the estimated signals. For example, in one embodiment, the stochastic update module 204 may apply a stochastic adjustment to each of the signals in the estimated signal set ŝ. In another embodiment, the stochastic5 update module 204 may apply a stochastic update to only the subset of signals for which the projection module 202 updates the estimates.

One of the issues with typical successive interference cancellation (SIC) and its variations is error-propagation, where an error in a cancellation stage propagates to future stages in a non-recoverable fashion. This undesirable feature may limit techniques to those cases where the signal-to-interference-plus-noise ratio (SINR) is large, i.e. where H^{T}H is strongly diagonal in a system model such as y=Hs+n. Another key issue in iterative techniques is that its gradient descent like behavior may lead to cycles where the DSP 150 is trapped in local minima. Using the stochastic update module 204 to make a stochastic update, in certain embodiments, may mitigate these drawbacks.

Various algorithms or steps used by the stochastic update module 204 to adjust estimated signals are described below. In various embodiments, since the signal to be estimated is known to be contaminated with some form of interference, the stochastic update module 204 may draw the adjustment from a probability distribution of the noisy signal. Therefore, we will first derive the appropriate distribution here, apply appropriate approximations, and then use the distribution to generate stochastic estimates.

First, we define the residual error vector e which contains noise and error due to the current estimate ŝ of the true symbols s as in

e=y−Hŝ (18)

ŝ=s+Sₑᵣᵣₒᵣ (19)

Next a stochastic adjustment Γ is selected where

[symbol]

=ŝₙₑₓₜ−ŝ≈s−ŝ. (20)

Finally, the error vector is updated (e.g., by the interference cancellation module) so that

eₙₑₓₜ=e− [symbol] (21)

where [symbol] is constructed from a subset of the vectors hᵢ enumerated by [symbol] . Selection of [symbol] and construction of [symbol] are described above with reference to the projection modulo 202. In the brief preceding outline of the stochastic adjustment, the stochastic update module 204 may select [symbol] from the distribution P( [symbol] |e, [symbol] ). If we model [symbol] as a multivariate Gaussian random vector which is causing interference in e, we may use

P(ƒ|e, [symbol] ,Θ)=((2π)^{M}|Σ|)^{-1/2} exp(−½(ƒ−Θ)^{T}Σ⁻¹(ƒ−Θ) (22)

where ƒ is of size M×1, [symbol] is constructed of M vectors of hᵢ of size N×1, Θ and Σ are the mean and covariance of the distribution, and |Σ|:=det Σ Therefore, the mean may be found and removed from e with the previously presented generalized projection and cancellation approach as follows:

[symbol]

= [symbol] (23)

[symbol]

= [symbol] − [symbol] (24)

e′=e− [symbol] (25)

which is what a deterministic interference canceller without a stochastic update module 204 performs by attempting to completely remove a portion of the interference. This allows for a simplification, in one embodiment, where stochastic update module 204 selects a stochastic adjustment [symbol] from a distribution based on the above zero-mean error vector e′, where the distribution is

P( [symbol] |e′, [symbol] )=((2π)^{M}|Σ|)^{-1/2} exp(−½ [symbol] ) (26)

The covariance matrix can be defined for the e′ case as

$$\begin{matrix}\sum = Cov ( Δ {s}_{𝒜}^{′} ) \\ \approx Cov ( {G}_{𝒜}^{†} {e}^{′} ) \\ = 𝔼 [ ( {( {G}_{𝒜}^{T} {G}_{𝒜} )}^{- 1} {G}_{𝒜}^{T} {e}^{′} ) {( {( {G}_{𝒜}^{T} {G}_{𝒜} )}^{- 1} {G}_{𝒜}^{T} {e}^{′} )}^{T} ] \\ = {( {G}_{𝒜}^{T} {G}_{𝒜} )}^{- 1} {G}_{𝒜}^{T} 𝔼 [ {e}^{′} {e}^{′ T} ] {{G}_{𝒜} ( {G}_{𝒜}^{T} {G}_{𝒜} )}^{- 1} \\ = {{σ}_{e}^{2} ( {G}_{𝒜}^{T} {G}_{𝒜} )}^{- 1}\end{matrix} \qquad ( 27 )$$

Here, the final step follows from an assumption that the elements of the vector e′ are independent and identically distributed. Therefore, [symbol] [e′e′^{T}]=σₑ²I and thus we can make the single sample estimate

$${σ}_{e}^{2} \approx \frac{{‖ {e}^{′} ‖}^{2}}{2 {N}_{r}} \qquad ( 28 )$$

Substituting back into Eq. 26 6we obtain the distribution

$$P ( Δ {s}_{𝒜}^{′} \vert {e}^{′} , {G}_{𝒜} ) \approx {( {( 2 π )}^{M} {σ}_{e}^{2} det ( {( {G}_{𝒜}^{T} {G}_{𝒜} )}^{- 1} ) )}^{- \frac{1}{2}} exp ( \frac{- {‖ {G}_{𝒜} Δ {s}_{𝒜}^{′} ‖}^{2}}{2 {σ}_{e}^{2}} ) \qquad ( 29 )$$

The algorithm so far described includes the stochastic update module 204 taking the current symbol estimate ŝ from the projection module 202, finding and applying a change [symbol] through generalized projection, and applying a stochastic adjustment [symbol] . The final step can be done by generating white noise v˜N(0, σₑ²I) and shaping it as in

[symbol]

= [symbol] . (30)

A simplification can be made by first adding the white noise v to the error vector e and then applying the generalized projection only once as in

$$\begin{matrix}{\hat{s}}_{next} = \hat{s} + Δ {s}_{𝒜 , μ} + Δ {s}_{𝒜}^{′} \\ = \hat{s} + {G}_{𝒜}^{†} e + {G}_{𝒜}^{†} v \\ = \hat{s} + {G}_{𝒜}^{†} ( e + v )\end{matrix} \qquad ( 31 )$$

The factorization in Eq. 31 is equivalent to two different ways for the stochastic update module 204 to make a stochastic adjustment to the signal estimates produced by the projection module 202. In one embodiment, the expression ŝ+ [symbol] + [symbol] corresponds to the stochastic update module 204 taking the current symbol estimate ŝ from the projection module 202, generating noise, and transforming the generated noise and the error vector based on [symbol] , which is the same subset of the mapping information H that the projection module 202 uses to update a subset of the symbol estimate g. In another embodiment, the expression ŝ+ [symbol] (e+v) corresponds to the stochastic update module 204 generating noise and adding the generated noise to the error information prior to the projection module 202 using [symbol] to update a subset of the symbol estimate ŝ.

In another embodiment, the stochastic update module 204 may use a static variance σₑ² to generate the noise, in place of the dynamic one shown above. One good static value to use is the noise variance σₙ². In high signal-to-noise ratio (SNR) situations, this value may be too small resulting, in some embodiments, in [symbol] values less than a constellation lattice spacing and thus a stalled stochastic interference canceler. When the noise variance becomes too small, a good alternative static choice for σₑ² is for the stochastic update module 204 to select it such that the mean variance of Δs′ will be equal to the average minimum spacing between valid data points. For a QAM constellation with minimum lattice spacing of 2 this results in

$${σ}_{e}^{2} = max ( \frac{1}{2 {\sum }_{j} {‖ {[ {G}_{𝒜}^{†} ]}_{j} ‖}^{2}} , {σ}_{n}^{2} ) \qquad ( 32 )$$

where [ [symbol] ]ⱼ is the j^{th} row of [symbol] .

In some embodiments, the stochastic update module 204 may place further restrictions on the σₑ² error-variance term to improve performance. For instance, the term can be bounded from above by the constellation size. Also, the magnitude of the individual elements Δsᵢ of the stochastic adjustment may be limited in magnitude to allow for smaller bit widths and thus a lower system complexity. In some embodiments, stochastic adjustment steps may be repeated by the stochastic update module 204 even after all the signals have been estimated by the projection module 202, to improve performance.

The term generated noise as used herein, may refer to random values selected from a probability distribution, as described above. In one embodiment, the stochastic update module 204 may generate noise randomly or pseudo-randomly. In another embodiment, the stochastic update module 204 may receive generated noise from an external source, such as a component that physically generates random noise, and may shape the noise based on the desired probability distribution. In certain embodiments, the stochastic update module 204 is configured to adjust the estimated signals by generating the noise based on a Gaussian probability distribution, as described above. In further embodiments, variance for the Gaussian probability distribution is based on a variance σₙ² for channel noise, or on the error information (e.g., with σₑ² based on ∥e′∥²), both of which are described above.

Additionally, in a certain embodiment, the stochastic update module 204 may be configured to quantize the updated estimated signals from the projection module 202, or the adjusted estimated signals after the stochastic adjustment, based on a finite set of possible valid signals, such as a QAM constellation, a PSK constellation or the like. For example, in one embodiment, the stochastic update module 204 may make a stochastic adjustment to the estimated signals from the projection module 202 and may apply a further adjustment moving the estimated signals to the nearest valid QAM signals. In another embodiment, the stochastic update module 204 may inject noise into the error vector prior to the projection module 202 updating a subset of signal estimates, and the stochastic update module 204 may subsequently quantize the updated signal estimates.

The interference cancellation module 206, in various embodiments, is configured to update the error information e based on the adjusted estimated signals produced by the stochastic update module 204 in cooperation with the projection module 202. Updating the error information may result in error information e=y−Hŝ, as described above, where ŝ includes the most current updated and stochastically adjusted signal estimates. Various algorithms or steps used by the interference cancellation module 206 to update the error information are described above with reference to the error information updates that occur along with the operations of the projection module 202 and the stochastic update module 204. For example, in one embodiment, the interference cancellation module 206 may update error information by subtracting the effects Hŝ of the most recent stochastically adjusted signal estimates directly from the received signal vector y. In another embodiment, the interference cancellation module 206 may update error information by adjusting a prior error vector based only on intervening changes to the signal estimates. In one embodiment, the interference cancellation module 206 may update the error vector first when the projection module 202 updates the signal estimates, and again when the stochastic update module 204 adjusts the signal estimates. In another embodiment, the interference cancellation module 206 may delay updating the error vector until the stochastic adjustment is ready.

In certain embodiments, the projection module 202, the stochastic update module 204 and the interference cancellation module 206 are configured to iteratively update and adjust estimated signals and update the error information as described above, until stopping. As described above, the projection module 202 may iterate through multiple sets of indices until the received signals have each been estimated at least once. In certain embodiments, the stochastic update module 204 may apply stochastic adjustments for each set of signal indices, or may apply stochastic adjustments more infrequently. Additionally, in certain embodiments, iterations may continue (e.g., reusing sets of indices) to refine previous signal estimates. A DSP 150 may stop the iterations based on a stopping condition occurring, such as a fixed elapsed time, a fixed number of iterations, a threshold for the error information (e.g. a sufficiently small norm for the error vector), a threshold for improvement in the error information (e.g., the norm of the error vector fails to change sufficiently over a certain number of iterations), successful ECC decoding, or the like, or based on any combination of such conditions.

In one embodiment the stopping criterion or condition may be based on a fixed number of iterations chosen from experimentation for desired performance. In another embodiment iterations may continue for a fixed number of iterations based upon the maximum time permitted by the system constraints. In another embodiment, the iterations may be stopped after the algorithm has converged to an estimate ŝ which is close to the expected correct solution, such as E(∥e_{correct ŝ}∥²)≈2Nᵣσₙ². Alternatively, the lack of ∥e∥² improvement over a number of iterations may be used to determine stopping. Finally, another stopping criterion is after confirmation of correctness from an error correction code.

FIG. 3 depicts another embodiment of a digital signal processor 150. In the depicted embodiment, the DSP 150 includes one or more projection modules 202, stochastic update modules 204 and interference cancellation modules 206, substantially as described above with regard to FIG. 2. A STIC 350 comprises a single projection module 202, stochastic update module 204 and interference cancellation module 206, as described above. In the depicted embodiment, the DSP 150 may include a plurality of projection modules 202, stochastic update modules 204, and interference cancellation modules 206 (e.g., multiple STICs 350) configured to operate in parallel to generate the plurality of estimated signal sets. Additionally, in the depicted embodiment, the DSP 150 includes an output module 302 (including a combination module 304), and includes an ECC decoder module 306.

In one embodiment, multiple parallel STICs 350a-n can be run in parallel to generate more symbol estimates ŝ more quickly and to increase the diversity of samples. The best results of iterations across parallel STICs 350 can be combined by the combination module 304. In certain embodiments parallel STICs 350 may be initialized differently. For example, in various embodiments, projection modules 202 in different STICs 350 may select initial signal estimates may be selected differently, or may iterate over different sets of indices, updating the signal estimates in different orders. Additionally, stochastic update modules 204 may provide non-deterministic behavior so that parallel STICs 350 produce a diversity of signal estimates.

The output module 302, in the depicted embodiment, is configured to output information based on the updated or adjusted set of estimated signals. Information output by the output module 302 may be received by the ECC decoder module 306, output as data 114 from the receiver 112, or the like. In one embodiment, the information may be “hard information,” which includes the signal estimates themselves, or at least one of the signal estimates. In another embodiment, the information may be “soft information” which is probabilistic information for at least one bit of the estimated signals. Soft information may indicate the likelihood that a bit is a 1, the likelihood that the bit is a 0, a ratio of the above likelihoods, a log of the likelihood ratio, individual log-likelihoods, or the like.

Various algorithms or steps used by the output module 302 to output information are described below. In certain embodiments, the output information from the output module 302 may feed into an error-correcting code (ECC) decoder (e.g., the ECC decoder module 306 or an external ECC decoder, which may be a low-density parity-check (LDPC) decoder or another type of ECC decoder) for further improvement. The output can be the best estimate of the transmitted bits, known as hard information, or the output can be soft information where the output represents the probability or likelihood of the transmitted bits. Soft output may provide improved performance. In one embodiment, the output module 302 may provide hard output in the form of the estimate ŝ which minimizes the objective function

$${min}_{\hat{s}} {‖ y - H \hat{s} ‖}^{2} .$$

In a certain embodiment, the output module 302 may provide soft-output values in the form of log likelihood ratios (LLRs) as in

$${λ}_{k}^{e} = \frac{1}{2 {σ}_{n}^{2}} ( {min}_{{\hat{s}}^{k -} ∈ {𝒮}^{k -}} {‖ y - H {\hat{s}}^{k -} ‖}^{2} - {min}_{{\hat{s}}^{k +} ∈ {𝒮}^{k +}} {‖ y - H {\hat{s}}^{k +} ‖}^{2} ) \qquad ( 33 )$$

where [symbol] and [symbol] are the sets of all estimated symbols ŝ with the k^{th}-bit 0 and 1, respectively. In effect, the soft information is based on the relative size of the error vector for the best estimate where the kth-bit is 0 and the best estimate where the k^{th}-bit is 1.

Note that the

$${min}_{{\hat{s}}^{k -} ∈ {𝒮}^{k -}} {‖ y - H {\hat{s}}^{k -} ‖}^{2} and {min}_{{\hat{s}}^{k +} ∈ {𝒮}^{k +}} {‖ y - H {\hat{s}}^{k +} ‖}^{2}$$

can be accumulated efficiently at the end of each iteration by calculating the L₂-norm of the error vector e and storing the minimum for each k^{th}-bit. Since only the minimum ∥e ∥² is used for each k^{th}-bit, multiple parallel STICs 350 can be run in parallel to generate more symbol estimates ŝ more quickly and to increase the diversity of samples.

The combination module 304, in certain embodiments, may generate output information based on a plurality of estimated signal sets ŝ. In one embodiment, the combination module 304 may combine estimated signal sets ŝ from multiple iterations of a STIC 350. In another embodiment, the combination module 304 may combine estimated signal sets from multiple STICs 350. In certain embodiments, the combination module 304 may select results across multiple iterations and STICs 350. For example, the combination module 304 may pick the best signal estimate for hard information, or may combine signal estimates to generate an LLR for the k^{th}-bit of a signal, as described above.

The error-correcting code (ECC) decoder module 306, in the depicted embodiment, is configured to decode ECC codewords based on the information from the output module 302. Decoding ECC codewords based on the information from the output module 302 may include receiving the hard information or soft information, applying a decoding algorithm for an error-correcting code (many of which are known, and some of which may yet be discovered or invented), and outputting a decoded set of bits corresponding to an encoded codeword. Additionally, certain types of ECC decoders (e.g., in an ECC decoder module 306) may themselves output soft information such as LLR values. Thus, in certain embodiments, the output module 302 may use additional soft information from the ECC decoder module 306 to output modified soft information.

It is also possible for the DSP 150 to use turbo equalization for improved performance. For example, in a turbo loop configuration, the output module 302 may produce soft LLR information on an ongoing basis, as STICs 350 iterate to produce and update signal estimates. In the turbo loop, the soft information from the output module 302 is fed forward to the ECC decoder module 306, and the ongoing LLR updates from the ECC decoder module 306 are fed back to the output module 302. For detailed information on Turbo equalization see Tuchler, et al., “Turbo equalization: An overview”, IEEE Transactions on Information Theory, 57.2, 920-952, 2011.

In certain embodiments, a STIC 350 may continuously produce sample estimates of the solution. Therefore, a STIC 350 (or parallel STICs 350) can be used in an online-Turbo configuration where a snapshot of the output can be sent to the ECC decoder module 306 while the STIC 350 is still running. The ECC decoder module 306 can then feed prior information back to update the STIC 350 without stopping the iterations of the STIC 350.

As described above, the output module 302 may obtain a list of the estimated symbols ŝ may, and may calculate the extrinsic LLR values λₖ^{e}. The output λₖ^{e} may be passed to the ECC decoder module 306, and the output from the ECC decoder module 306 may be fed to the output module 302 to improve the bit error rate as follows

$${λ}_{k}^{e} = {min}_{{\hat{s}}^{k -} ∈ {𝒮}^{k -}} [ \frac{1}{2 {σ}_{n}^{2}} {‖ y - H {\hat{s}}^{k -} ‖}^{2} - \frac{1}{2} {\hat{b}}^{\backslash k} \cdot Λ ( {\hat{b}}^{\backslash k} ) ] - {min}_{{\hat{s}}^{k +} ∈ {𝒮}^{k +}} [ \frac{1}{2 {σ}_{n}^{2}} {‖ y - H {\hat{s}}^{k +} ‖}^{2} - \frac{1}{2} {\hat{b}}^{\backslash k} \cdot Λ ( {\hat{b}}^{\backslash k} ) ] \qquad ( 8 )$$

where \hat{b}^{\k} is the mapped bit vector of ŝ without the k^{th}-bit, and Λ (\hat{b}^{\k}) is the vector of the LLR output values from the ECC decoder module 306 without the k^{th}-value. The list of estimated symbols ŝ generated from the a first run of a STIC 350 may be used in the second and subsequent turbo iterations to reduce complexity, or a STIC 350 may be re-run to regenerate the list of estimated symbols ŝ for each turbo iteration. Additionally, a projection module 202 may determine initial conditions to use the symbol estimate ŝ₀ calculated from the LLR output values of the ECC decoder module 306, i.e. ŝ₀=ŝ_{ECC} which may be the hard or soft symbol estimate computed from the output LLR values of the ECC decoder module 306, or any prior information available to the STIC 350.

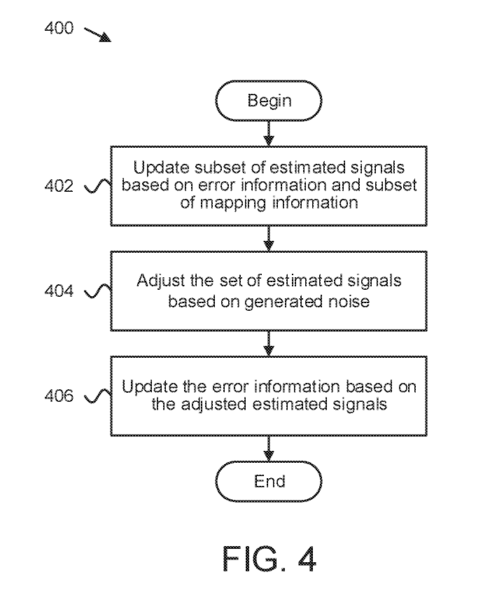

FIG. 4 is a schematic flow chart diagram illustrating one embodiment of a method 400 for stochastic interference cancellation. The method 400 begins, and a projection module 202 updates 402 a subset of a set of estimated signals, based on error information and on a corresponding subset of mapping information. A stochastic update module 204 adjusts 404 the set of estimated signals based on generated noise. An interference cancellation module 206 updates 406 the error information based on the adjusted estimated signals, and the method 400 ends. In certain embodiments, the method 400 may be performed in a single iteration of a STIC 350, and may be repeated to iteratively update signal estimates.

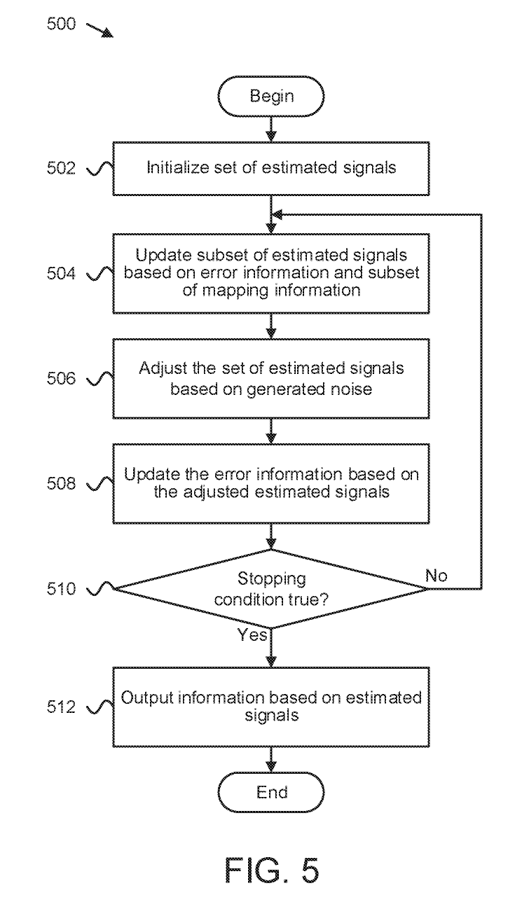

FIG. 5 is a schematic flow chart diagram illustrating another embodiment of a method 500 for stochastic interference cancellation. The method 500 begins, and a projection module 202 initializes 502 a set of estimated signals. The projection module 202 updates 504 a subset of the estimated signals, based on error information and on a corresponding subset of mapping information. A stochastic update module 204 adjusts 506 the set of estimated signals based on generated noise. An interference cancellation module 206 updates 508 the error information based on the adjusted estimated signals, A DSP 150 or a STIC 350 determines 510 whether a stopping condition is true. If the stopping condition is true, an output module 302 outputs 512 information based on the estimated signals, and the method 500 ends. If the stopping condition is not true, the method 500 continues in another iteration, with the projection module 202 updating 504 another subset of the estimated signals. Additionally, in certain embodiments, the output module 302 may output 512 information continuously, regardless of whether the stopping condition is true (e.g., as the signal estimates are iteratively updated and adjusted).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a digital signal processor configured to decode a set of transmitted signals based on a set of received signals, the digital signal processor comprising:
a projection module configured to update a subset of a set of estimated signals based on error information and on a corresponding subset of mapping information, wherein the error information is based on the received signals and the set of estimated signals, and the mapping information indicates how the received signals are affected by the transmitted signals;
a stochastic update module configured to adjust the set of estimated signals based on generated noise; and
an interference cancellation module configured to update the error information based on the adjusted estimated signals,
wherein the projection module, the stochastic update module, and the interference cancellation module comprise one or more of hardware circuits, programmable hardware circuits and executable code, the executable code stored on one or more computer readable storage media.

2. The apparatus of claim 1, wherein the digital signal processor is a multiple-input multiple-output (MIMO) decoder configured to receive signals from a plurality of receive antennas, wherein the received signals are based on the transmitted signals from a plurality of transmit antennas and on channel effects comprising one or more of attenuation, delay, noise, and interference.

3. The apparatus of claim 1, further comprising an output module configured to output information based on the updated set of estimated signals, wherein the information comprises one or more of:
hard information comprising at least one estimated signal; and
soft information for at least one bit, based on the updated set of estimated signals.

4. The apparatus of claim 3, wherein the output module comprises a combination module configured to generate the information based on a plurality of estimated signal sets.

5. The apparatus of claim 4, further comprising a plurality of projection modules, stochastic update modules, and interference cancellation modules configured to operate in parallel to generate the plurality of estimated signal sets.

6. The apparatus of claim 3, further comprising an error-correcting code (ECC) decoder module configured to decode ECC codewords based on the information from the output module, wherein the output module is further configured to use additional soft information from the ECC decoder module to output modified soft information.

7. The apparatus of claim 1, wherein the stochastic update module is configured to adjust the set of estimated signals by generating the noise based on a Gaussian probability distribution, and one of:
transforming the generated noise and the error information based on the subset of the mapping information; and
adding the generated noise to the error information prior to the projection module updating the subset of estimated signals.

8. The apparatus of claim 7 wherein a variance for the Gaussian probability distribution is based on one of:
a variance for channel noise; and
the error information; and

9. The apparatus of claim 1, wherein the stochastic update module is further configured to quantize the updated estimated signals based on a finite set of possible valid signals.

10. The apparatus of claim 1, wherein the subset of mapping information corresponds to one of:
a single transmitted signal;
two or more transmitted signals selected from the set of transmitted signals; and
the set of transmitted signals.

11. The apparatus of claim 1, wherein the subset of mapping information corresponds to two or more transmitted signals selected from the set of transmitted signals based on cross correlations in the mapping information.

12. The apparatus of claim 1, wherein the projection module, the stochastic update module and the interference cancellation module are configured to iteratively update and adjust estimated signals and update the error information until stopping based on one or more of a fixed elapsed time, a fixed number of iterations, a threshold for the error information, a threshold for improvement in the error information, and successful error-correcting code (ECC) decoding.

13. The apparatus of claim 12, wherein an initial set of estimated signals is one of:
a set of zero-amplitude signals;
a set of estimated signals from an external source; and
a set of symbols selected from a finite set of possible valid signals.

14. A system comprising:
a plurality of receive antennas that receive a set of signals; and
digital signal processing circuitry that decodes a set of transmitted signals based on the set of received signals, wherein the digital signal processing circuitry:
updates a subset of a set of estimated signals based on error information and on a corresponding subset of mapping information, wherein the error information is based on the received signals and the set of estimated signals, and the mapping information indicates how the received signals are affected by the transmitted signals;
adjusts the set of estimated signals based on generated noise; and
updates the error information based on the adjusted estimated signals.

15. The system of claim 14, wherein the digital signal processing circuitry adjusts the set of estimated signals by generating the noise based on a Gaussian probability distribution, and one of:
transforming the generated noise based on the subset of the mapping information; and
adding the generated noise to the error information prior to the projection module updating the subset of estimated signals.

16. The system of claim 14, wherein the digital signal processing circuitry quantizes the updated estimated signals based on a finite set of possible valid signals.

17. The system of claim 14, wherein the subset of mapping information corresponds to one of:
a single transmitted signal;
two or more transmitted signals randomly selected from the set of transmitted signals; and
the set of transmitted signals.

18. The system of claim 14, wherein the subset of mapping information corresponds to two or more transmitted signals selected from the set of transmitted signals based on cross correlations in the mapping information.

19. A method comprising:
updating a subset of a set of estimated signals based on error information and on a corresponding subset of mapping information, wherein the error information is based on a set of received signals and the set of estimated signals, and the mapping information indicates how the received signals are affected by the transmitted signals;
adjusting the set of estimated signals based on generated noise; and
updating the error information based on the adjusted estimated signals.

20. The method of claim 19, further comprising initializing the set of estimated signals to one of: a set of zero-amplitude signals and a set of estimated signals from an external source;
iteratively updating and adjusting estimated signals and updating the error information until stopping based on one or more of a fixed elapsed time, a fixed number of iterations, a threshold for the error information, a threshold for improvement in the error information, and successful error-correcting code(ECC) decoding; and
outputting information based on one or more estimated signals.
